(19) United States
(12) Patent Application Publication
(10) Pub. No.: US 2012/0218241 A1
(43) Pub. Date: Aug. 30, 2012

(54) DRIVING METHOD FOR IMPROVING STABILITY IN MOTFTs

(76) Inventors: Chan-Long Shieh, Paradise Valley, AZ (US); Gang Yu, Santa Barbara, CA (US)

(21) Appl. No.: 13/034,458

(22) Filed: Feb. 24, 2011

(51) Int. Cl. G06F 3/038

(52) U.S. Cl. 345/211; 345/204

(57) ABSTRACT

A method of driving a display device includes providing an array of pixels including rows and columns of pixels, each pixel including a switching/driving transistor circuit and at least one light emitting device. Each row of pixels has a scan line and each column of pixels has a data line. The method further includes defining a frame period during which each pixel in the array of pixels is addressed and dividing the frame period into a write subframe, a display subframe, and a rest subframe. A scan pulse is supplied to each scan line, a data signal to each data line and the light emitting devices are disabled during the write subframe. The light emitting devices are enabled during the display subframe and the switching/driving transistor circuits are disabled. A rest pulse is supplied to all scan lines and the light emitting devices are disabled during the rest subframe.

### FIELD OF THE INVENTION

This invention generally relates to stability in MOTFTs and more specifically to a driving method for improving stability in MOTFTs.

### BACKGROUND OF THE INVENTION

Metal oxide thin film transistors (MOTFTs) are used in a variety of devices but primarily in the active circuits incorporated into active matrices in displays. The stability of the MOTFTs (i.e. the threshold voltage at which the MOTFT is turned on or off) is critical in many of the operations performed by the MOTFTs. See for example the discussion about positive threshold voltage shifts in a TFT in copending U.S. patent application entitled “Metal Oxide TFT with Improved Stability”, filed 29 Oct. 2010, Ser. No. 12/915,712, and incorporated herein by reference.

The stability of a MOTFT is controlled by the resistance to oxidation and the reduction of the metal oxide. Instability of the MOTFT under positive bias is due to susceptibility to oxidation. Instability of the MOTFT under negative bias is due to susceptibility to reduction. Since oxidation is the reverse operation of reduction, the resistance to oxidation is the reverse of the resistance to reduction. Stability under a positive bias (resistance to oxidation) is usually at the expense of stability under a negative bias (resistance to reduction) and vice versa.

It is hard to provide a metal oxide that is stable under both a positive bias and a negative bias. To achieve a MOTFT (especially those with a large energy gap) that is stable under positive bias, the TFT channel must be resistant to oxidation. On the other hand, to achieve a MOTFT that is stable under negative bias, the TFT channel must be resistant to reduction. It is a major challenge to provide a MOTFT that is stable for both positive and negative biases.

Because of the ionic nature of metal oxides, the stability of the MOTFT is better under a balanced AC driven condition than under a DC driven condition. It is advantageous to be able to drive the MOTFT under a balanced AC condition.

Under negative bias, the reduction process in a MOTFT is relatively slow and can be frustrated by a pulsed bias. In a period less than approximately 20 msec for example, the negative bias can be removed or even reversed by applying a positive bias for a short time to frustrate the reduction process. It has been observed, for example that the stability is greatly improved by removing the negative bias (e.g. returning to zero bias) at a 50% duty cycle. When the pulse period is shorter than 20 msec, for example, it has been observed that the threshold voltage stability can be sustained with a smaller duty cycle, even as low as 1% of the period. This is in a great contrast to those devices produced in covalent semiconductors such as in TFTs made of a-Si or LIPS. On the other hand, the effect of pulsed positive bias removal on the stability of a MOTFT is less prominent.

In the primary uses or uses-of-interest for MOTFTs, the transistors can be used as a simple transistor switch or as a driver transistor. In LCD or EPD applications, for example, the MOTFT is used as a switch (shown in FIG. 1). The switch transistor is turned ON (under positive bias) for a short time and turned OFF (under negative bias) the rest of the time. The duty cycle is less than 1% and can be much less. In this application the MOTFT switch transistor requires stability under mostly negative bias.

For OLED applications, additional drive transistors are needed to deliver current to the OLED diodes (shown in FIG. 2). The characteristic of drive transistors is that the current is flowing most of the time corresponding to the brightness of the pixels. In this application the MOTFT is under positive bias most of the time. The MOTFT drive transistor in this application requires stability under positive bias.

Further, as can be seen in FIG. 2, for OLED applications, a MOTFT switch transistor is also used. The switch transistor is turned ON (under positive bias) for a short time and turned OFF (under negative bias) the rest of the time. The MOTFT driver is optimized for stability of the drive transistor, which is more critical because of its analog nature. As explained above, the stability of a MOTFT under negative bias conditions is compromised. Thus, for OLED driving applications with the MOTFT optimized for the driving function, the negative biased switch transistor may become an issue.

For the new generation of LCDs, a high mobility MOTFT backplane is needed. In order to achieve high mobility, the metal oxide should have high free electron density and should be resistant to oxidation (oxidation reduces free electrons). Therefore, high mobility MOTFTs tend to be less stable under negative bias. Further, as the number of scan lines in a display increases, the duty cycle of the negative bias removal becomes less so that the switch transistor is almost always under negative bias.

In typical video display applications, the switch transistor is already under pulsed bias operation, that is, the negative bias is removed (turned to positive bias) for a short duration in each frame. The duration of the negative bias removal is the frame time (determined by the number of frames per second) divided by the number of scan lines. The duty cycle of negative bias removal is the inverse of the number of scan lines. For example, in a 1000 scan line display, the duty cycle is 0.1%. Such a low duty cycle may not be sufficient to provide the desired stability in a MOTFT. That is the natural negative bias removal under ordinary switching/driving conditions may not provide enough negative bias removal to make the switch transistor stable. It would be advantageous to provide a new driving method and apparatus to help make the switch transistor more stable by providing a negative bias removal time that is independent of the number of scan lines.

Accordingly, it is an object of the present invention to provide a new and improved driving method for displays.

It is another object of the present invention to provide a new and improved driving method to improve the stability of switch transistors.

It is another object of the present invention to provide a new and improved driving method for producing a negative bias removal time to MOTFT switch transistors that is independent of the number of scan lines in a display.

It is another object of the present invention to provide a new and improved driving method for displays that does not increase the cost and that is easy to implement.

It is another object of the present invention to provide a new and improved driving method for displays including a blanking time that improves the comfort level during viewing.

### SUMMARY OF THE INVENTION

Briefly, to achieve the desired objects of the instant invention in accordance with a preferred embodiment thereof provided is a method of driving a display device that includes providing an array of pixels with rows and columns of pixels, each pixel including a switching/driving transistor circuit and at least one light emitting device. Each row of pixels has a scan line and each column of pixels has a data line. The method further includes defining a frame period during which each pixel in the array of pixels is addressed and dividing the frame period into a write subframe, a display subframe, and a rest subframe. A scan pulse is supplied to each scan line, a data signal to each data line and the light emitting devices are disabled during the write subframe. The light emitting devices are enabled during the display subframe and the switching/driving transistor circuits are disabled. A rest pulse is supplied to all scan lines and the light emitting devices are disabled during the rest subframe. Whereby, the new driving method helps make the switch transistors more stable by providing a negative bias removal time that is independent of the number of scan lines.

The desired objects of the instant invention are further achieved in accordance with a display device with driving apparatus including an array of pixels and associated circuitry with rows and columns of pixels defining a display, each pixel in the array of pixels including a switching/driving transistor circuit and at least one light emitting device, each row of pixels having a scan line coupled to each switching/driving transistor circuit of each pixel in the row and each column of pixels having a data line coupled to each switching/driving transistor circuit of each pixel in the column. The array of pixels includes a frame period during which each pixel in the array of pixels is addressed and the frame period is divided into a write subframe, a display subframe, and a rest subframe. The associated circuitry is designed to supply a scan pulse to each scan line, to supply a data signal to each data line and to disable the light emitting devices during the write subframe. The associated circuitry is further designed to enable the light emitting devices during the display subframe and disable the switching/driving transistor circuits. The associated circuitry is further designed to supply a rest pulse to all scan lines and to disable the light emitting devices during the rest subframe. Whereby, the new driving apparatus helps make the switch transistors more stable by providing a negative bias removal time that is independent of the number of scan lines.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a simplified schematic diagram of a MOTFT switch circuit for a single LCD/EPD display element;

FIG. 2 is a simplified schematic diagram of one example of a MOTFT switch/drive circuit for a single OLED display element;

FIG. 3 is a simplified schematic diagram of another example of a MOTFT switch/drive circuit for a single OLED display element;

FIG. 4 illustrates the waveforms on the data lines of a display, in accordance with the present invention; and

FIG. 5 illustrates the pulse waveforms on the scan lines of a display, in accordance with the present invention.

### DETAILED DESCRIPTION OF THE DRAWINGS

Generally, this disclosure applies to display devices including rows and columns of pixels. Here it will be understood that each pixel includes at least one light generating (e.g. an OLED) or conducting device (e.g. an LCD or EPD) and can include as many as four, five, or more (e.g. for full color displays). The light generating and/or light conducting devices are hereinafter referred to as “light emitting devices”. Further, each row of pixels will have at least one scan line coupled thereto and each column of pixels will have at least one data line coupled thereto. For convenience of understanding a single scan line for each row and a single data line for each column will be described with the understanding that this description is intended to include multiple scan and data lines if used. Also while the terms ‘row’ and ‘column’ are used it will be understood that any display can be rotated whereby the rows and columns are reversed so that the scan and data lines are reversed and the disclosure and claims are intended to include such variables.

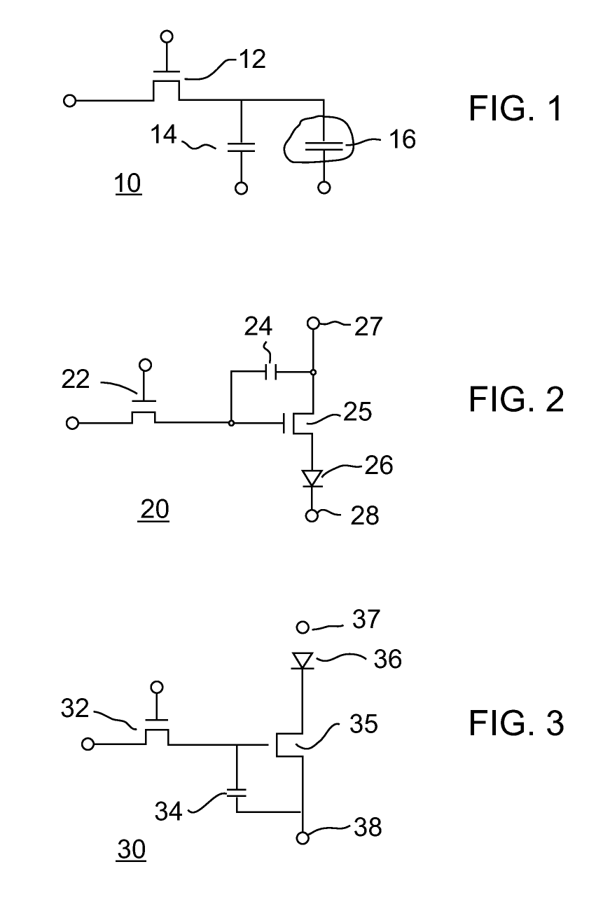

Referring specifically to FIG. 1, a typical switching/driving circuit 10 for LCD or EPD displays is illustrated. Switching/driving circuit 10 includes a metal oxide thin film transistor (MOTFT) 12 with a source/drain circuit connecting a data input line to one terminal of a storage capacitor 14. The opposite terminal of capacitor 14 is connected to a return. The gate of MOTFT 12 is connected to a scan input line. The source/drain circuit of MOTFT 12 is also connected to one terminal of an LCD or EPD, designated 16. The opposite terminal of LCD or EPD 16 is connected to a return, which may be the same return as that connected to capacitor 14 or may be a different return depending upon the specific construction of the system. In operation, the scan line switches MOTFT 12 ON for a short period of time while data is stored in capacitor 14. The data (charge) stored in capacitor 14 is then applied to LCD or EPD 16 to control the brightness according to the image being displayed. As understood, LCD or EPD 16 is activated, by the charge on the capacitor to conduct light therethrough from a backlight of some form and LCD or EPD 16 is or can be enabled or disabled by turning the backlight ON or OFF.

Referring now to FIG. 2, a typical switching/driving circuit 20 for OLED displays is illustrated. Switching/driving circuit 20 includes a switch transistor (MOTFT) 22 with a source/drain circuit connecting a data input line to one terminal of a storage capacitor 24 and the gate of a drive MOTFT 25. The gate of switch transistor 22 is connected to a scan input line. The source/drain circuit of MOTFT 25 connects a voltage source Vdd on a power terminal 27 to the positive terminal of an OLED 26. The other terminal of capacitor 24 is also connected to power terminal 27. The negative terminal of OLED 26 is connected to a common return 28 (typically referred to as a common cathode). In operation, the scan line switches MOTFT 22 ON for a short period of time while data is stored in capacitor 24. The data (charge) stored in capacitor 24 is applied to the gate of drive MOTFT 25 which supplies drive current to OLED 26 to control the brightness according to the image being displayed. As understood, OLED 26 and drive MOTFT 25 are enabled or activated by the voltage applied to terminal 27 (i.e. between terminals 27 and 28) to generate light for a pixel of the display.

Referring now to FIG. 3, another switching/driving circuit 30 for OLED displays is illustrated. Switching/driving circuit 30 includes a switch transistor (MOTFT) 32 with a source/drain circuit connecting a data input line to one terminal of a storage capacitor 34 and the gate of a drive MOTFT 35. The gate of switch transistor 32 is connected to a scan input line. A power terminal (Vdd) 37 is connected to the positive terminal of an OLED 36. The source/drain circuit of MOTFT 35 connects the cathode of OLED 36 to a common negative or return 38 (typically referred to as a common anode). The other terminal of capacitor 34 is also connected to power terminal 37. The negative terminal of OLED 36 is connected to common negative or return 38. In operation, the scan line switches MOTFT 32 ON for a short period of time while data is stored in capacitor 34. The data (charge) stored in capacitor 34 is applied to the gate of drive MOTFT 35 which supplies drive current to OLED 36 to control the brightness according to the image being displayed. As understood, OLED 36 and drive MOTFT 35 are enabled or activated by the voltage applied to terminal 37 (i.e. between terminals 37 and 38) to generate light for a pixel of the display.

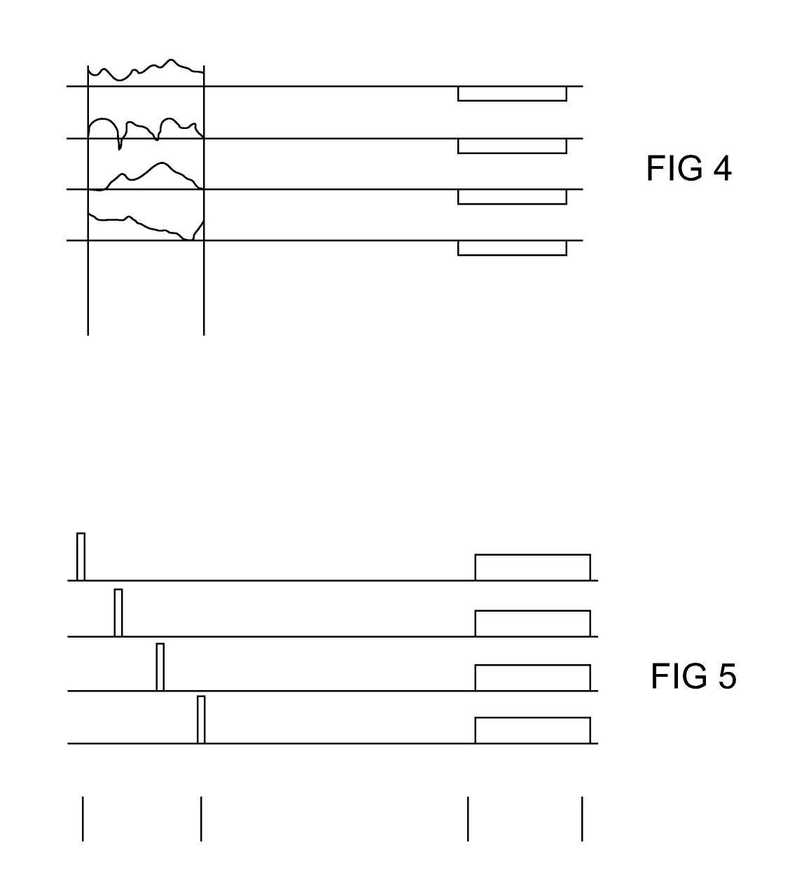

Referring additionally to FIGS. 4 and 5, waveforms applied to the data lines and waveforms applied to the scan lines for a driving scheme in accordance with the present invention are illustrated. Each waveform represents the operation of a single pixel during a single frame and, in accordance with the present invention each frame is divided into three subframes: a write subframe, a display subframe and a rest subframe.

During the writing subframe, the scan pulse is applied to the gate of the switch transistor and the data on the data line is written into the pixel storage capacitor as display and display devices are disabled. In this disclosure the term “disable” or “disabled” refers to any process or method by which the specific device or circuit is turned OFF or in a temporary non-functioning state. As explained above, LCDs or EPDs are disabled, for example, by turning off the backlights and OLEDs are disabled by removing or disconnecting the Vdd power source. The switching/driving transistor circuits can be disabled, for example, by simply not applying data to the data lines and/or not applying scan pulses to the scan lines (e.g. returning the scan lines to a quiescent state). The writing of data into the storage capacitors during the write subframe is similar to the operation of traditional active matrix driving schemes. During the writing subframe, the data stored in the storage capacitors may not reflect the image or show the image on the display until all of the writing is completed (i.e. until the end of the write subframe), which is why the display devices are disabled during the write subframe. The percentage of a total frame that the write subframe occupies is from approximately 5% to approximately 50%. It will be understood that the write pulses are sequentially cycled from the first scan line of the display to the last scan line of the display during the writing subframe. Also, the data lines deliver the time multiplexed video signal to spatially multiplexed storage capacitors to recover the image. Because of the short time period, the switch transistor must provide more current, which a MOTFT can readily achieve.

In the display subframe, all switch transistors are disabled by returning all scan lines to a quiescent voltage during the display subframe and the display device is enabled. Any signals on the data lines during the display subframe are irrelevant because all storage capacitors are isolated by the disabled or turned off switch transistors. As explained above, LCDs or EPDs are enabled, for example, by turning on the backlights and OLEDs are enabled by applying or connecting the Vdd power source. The image displayed is represented by the charges on the storage capacitors, which are well preserved during the display subframe because all switch transistors are disabled or turned off. The display will show the image as pixel capacitors manifest onto display devices. The percentage of a total frame that the display subframe occupies is from approximately 40% to approximately 90%. As will be understood, the size or extent of the display subframe is generally large compared to the other two subframes.

In the rest subframe, all switch transistors are turned on and all storage capacitors are written to a resting voltage or pulse. During the rest subframe, all scan lines receive a resting pulse, which turns on all switch transistors. The resting pulse is generally sufficiently long to provide reverse compensation for the switch transistors sufficient to substantially completely stabilize the switching transistors. The amplitude of the resting pulse may be different from the writing pulse. Also, during the rest subframe all display devices are disabled. The percentage of a total frame that the rest subframe occupies is from approximately 1% to approximately 50%. The three subframes must add up to a single frame. The duration of the rest subframe and consequently the duration of the resting pulse depends on a number of variables in the overall system, including for example the number of scan lines, the length of each frame, the amplitude of the resting pulse, the specific switch transistors used (e.g. material size, etc.), and any other variables in the system. The data lines provide a resting signal to the storage capacitor and to the gate of the drive transistor in OLED displays. The resting signal can also be used to provide some reverse compensation for the drive transistors.

Thus, a new and improved driving method for displays has been disclosed. The driving scheme is specifically designed to improve the stability of switch transistors and particularly to switch MOTFTs. The driving method is designed to produce a negative bias removal time to MOTFT switch transistors that is independent of the number of scan lines in the associated display. Also, the new and improved driving method for displays does not increase the cost and is easy to implement. Further, it has been found that the rest time or blanking time during each frame actually improves or contributes to eye relief and, hence, improves the comfort level during viewing.

Various changes and modifications to the embodiment herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A method of driving a display device comprising the steps of:
providing an array of pixels including rows and columns of pixels defining a display, each pixel in the array of pixels including a switching/driving transistor circuit and at least one light emitting device, each row of pixels having a scan line coupled to each switching/driving transistor circuit of each pixel in the row and each column of pixels having a data line coupled to each switching/driving transistor circuit of each pixel in the column;
defining a frame period during which each pixel in the array of pixels is addressed and dividing the frame period into a write subframe, a display subframe, and a rest subframe;
supplying a scan pulse to each scan line, a data signal to each data line and disabling the light emitting devices during the write subframe;
enabling the light emitting devices during the display subframe and disabling the switching/driving transistor circuits; and
supplying a rest pulse to all scan lines and disabling the light emitting devices during the rest subframe, whereby, the method of driving the display device makes the switch transistors more stable by providing a negative bias removal time that is independent of the number of scan lines.

2. A method as claimed in claim 1 wherein the scan lines are returned to a quiescent voltage during the display subframe to turn off all switching/driving transistor circuits.

3. A method as claimed in claim 1 wherein the write subframe is approximately 5% to approximately 50% of the total frame period.

4. A method as claimed in claim 1 wherein the display subframe is approximately 40% to approximately 90% of the total frame period.

5. A method as claimed in claim 1 wherein the rest subframe is approximately 1% to approximately 50% of the total frame period.

6. A method as claimed in claim 1 wherein the rest pulse is generally sufficiently long to provide reverse compensation for switch transistors in the switching/driving transistor circuits sufficient to substantially completely stabilize the switching transistors.

7. A method as claimed in claim 1 wherein the scan pulse and the rest pulse turn the switching/driving transistor circuits ON.

8. A method as claimed in claim 1 wherein the rest pulse provides some reverse compensation for a drive transistor in the switching/driving transistor circuit.

9. A method as claimed in claim 1 wherein the step of providing a switching/driving transistor circuit includes providing a MOTFT switch transistor in the switching/driving transistor circuit.

10. A method of driving a display device comprising the steps of:
providing an array of pixels including rows and columns of pixels defining a display, each pixel in the array of pixels including a switching/driving transistor circuit and at least one light emitting device, each row of pixels having a scan line coupled to each switching/driving transistor circuit of each pixel in the row and each column of pixels having a data line coupled to each switching/driving transistor circuit of each pixel in the column;
defining a frame period during which each pixel in the array of pixels is addressed and dividing the frame period into a write subframe, a display subframe, and a rest subframe, the write subframe being approximately 5% to approximately 50% of the total frame period, the display subframe being approximately 40% to approximately 90% of the total frame period, and the rest subframe being approximately 1% to approximately 50% of the total frame period;
supplying a scan pulse to each scan line, a data signal to each data line and disabling the light emitting devices during the write subframe;
enabling the light emitting devices during the display subframe and disabling the switching/driving transistor circuits; and
supplying a rest pulse to all scan lines and disabling the light emitting devices during the rest subframe, the rest pulse being generally sufficiently long to provide reverse compensation for switch transistors in the switching/driving transistor circuits sufficient to substantially completely stabilize the switching transistors.

11. A method as claimed in claim 10 wherein the scan pulse and the rest pulse turn the switching/driving transistor circuits ON.

12. A method as claimed in claim 10 wherein the rest pulse provides some reverse compensation for a drive transistor in the switching/driving transistor circuit.

13. A method as claimed in claim 10 wherein the scan lines are returned to a quiescent voltage during the display subframe to turn off all switching/driving transistor circuits.

14. A method as claimed in claim 10 wherein the step of providing a switching/driving transistor circuit includes providing a MOTFT switch transistor in the switching/driving transistor circuit.

15. A display device with driving apparatus comprising:
an array of pixels and associated circuitry including rows and columns of pixels defining a display, each pixel in the array of pixels including a switching/driving transistor circuit and at least one light emitting device, each row of pixels having a scan line coupled to each switching/driving transistor circuit of each pixel in the row and each column of pixels having a data line coupled to each switching/driving transistor circuit of each pixel in the column;
the array of pixels including a frame period during which each pixel in the array of pixels is addressed and the frame period being divided into a write subframe, a display subframe, and a rest subframe;
the associated circuitry being designed to supply a scan pulse to each scan line, to supply a data signal to each data line and to disable the light emitting devices during the write subframe;
the associated circuitry being designed to enable the light emitting devices during the display subframe and disable the switching/driving transistor circuits; and
the associated circuitry being designed to supply a rest pulse to all scan lines and to disable the light emitting devices during the rest subframe, whereby, the driving apparatus makes the switch transistors more stable by providing a negative bias removal time that is independent of the number of scan lines.

16. A display device with driving apparatus as claimed in claim 15 wherein the associated circuitry is designed to return the scan lines to a quiescent voltage during the display subframe to turn off all switching/driving transistor circuits.

17. A display device with driving apparatus as claimed in claim 15 wherein the associated circuitry is designed to supply a scan pulse and a rest pulse that turns the switching/driving transistor circuits ON.

18. A display device with driving apparatus as claimed in claim 15 wherein the at least one light emitting device includes one of an LCD, an EPD, or an OLED.

19. A display device with driving apparatus as claimed in claim 15 wherein the switching/driving transistor circuit includes a MOTFT switch transistor.
